(19) United States
(12) Patent Application Publication
(10) Pub. No.: US 2025/0030562 A1
(43) Pub. Date: Jan. 23, 2025

(54) SYSTEM TO FACILITATE BLOCKCHAIN-BASED AGREEMENTS

(71) Applicant: SaaSy Labs, Inc., Beverly Hills, CA (US)

(72) Inventors: Joshua Anderson, Beverly Hills, CA (US); Chris Grigoriou, Sheridan, WY (US)

(21) Appl. No.: 18/780,333

(22) Filed: Jul. 22, 2024

Related U.S. Application Data
(60) Provisional application No. 63/515,309, filed on Jul. 24, 2023.
(60) Provisional application No. 63/514,749, filed on Jul. 20, 2023.

(51) Int. Cl. H04L 9/32

(52) U.S. Cl. CPC H04L 9/3268; H04L 9/3265

(57) ABSTRACT

Agreements between parties are facilitated using templates in a system that validates and verifies the agreements to improve clarity or enforceability of the agreements. Blockchain methods are used such that the agreements may be properly recorded or stored. The method may include providing a template of an agreement and obtaining an agreement between a first entity and a second entity. The agreement is generated based on the first template and user input. The agreement is added to an agreement chain. A block that includes information associated with the agreement is submitted to be posted to a blockchain.

### CROSS REFERENCE TO RELATED APPLICATIONS

This application claims priority to and the benefit of U.S. Provisional Application No. 63/515,309, titled SYSTEM TO FACILITATE BLOCKCHAIN-BASED AGREEMENTS, filed Jul. 24, 2023, and U.S. Provisional Application No. 63/514,749, titled SYSTEM TO FACILITATE BLOCKCHAIN-BASED AGREEMENTS, filed Jul. 20, 2023, all of which are incorporated herein by reference in their entireties.

### FIELD

Embodiments of the present disclosure relate to a system to facilitate blockchain-based agreements.

### BACKGROUND

Different parties may desire to enter into a legal agreement to trade assets and/or services. Creating a legal agreement or contract involves several steps to ensure that the agreement is clear and enforceable. For example, the process may include negotiations, agreement drafting, essential clauses drafting, reviewing, modification, renewal, and/or termination, among others.

The subject matter claimed herein is not limited to embodiments that solve any disadvantages or that operate only in environments such as those described above. Rather, this background is only provided to illustrate one example technology area where some embodiments described herein may be practiced.

### SUMMARY

One or more embodiments of the present disclosure may include a system that includes one or more processors, and one or more non-transitory computer-readable media containing instructions which, when executed by the one or more processors, cause the system to perform one or more operations. The operations may include receiving identified express terms via which an offeror is willing to convey ownership in a non-fungible token (NFT) to another party; and receiving from a promisor a willingness to enter into an agreement according to the express terms to obtain ownership in the NFT. The operations may also include generating the agreement including the express terms; obtaining signatures from each of the promisor and the offeror for the agreement; and submitting a block including information associated with the agreement to be posted to a blockchain.

The object and advantages of the embodiments will be realized and achieved at least by the elements, features, and combinations particularly pointed out in the claims.

It is to be understood that both the foregoing general description and the following detailed description are merely examples and explanatory and are not restrictive.

### BRIEF DESCRIPTION OF THE DRAWINGS

Example embodiments will be described and explained with additional specificity and detail through the use of the accompanying drawings in which:

FIG. 1 is a diagram illustrating an example system which may operate as a blockchain-based system to facilitate agreements, in accordance with one or more embodiments of the present disclosure.

FIG. 2A is a swim lane diagram illustrating an example agreement creation workflow executed by the example system of FIG. 1.

FIG. 2B is a swim lane diagram illustrating an example asset transfer workflow executed by the example system of FIG. 1.

FIG. 2C is a swim lane diagram illustrating an example agreement payment workflow executed by the example system of FIG. 1.

FIG. 2D is a swim lane diagram illustrating an example agreement validation workflow executed by the example system of FIG. 1.

FIG. 3A illustrates use of the example system of FIG. 1 and the workflows of FIG. 2A-2D in the context of an intellectual property marketplace.

FIG. 3B illustrates use of the example system of FIG. 1 and the workflows of FIG. 2A-2D in the context of a community trademark marketplace.

FIG. 4 illustrates an example computing system, in accordance with one or more embodiments of the present disclosure.

FIG. 5 illustrates an example system which may operate as a block-chain based system to facilitate agreements, in accordance with one or more embodiments of the present disclosure.

FIG. 6 illustrates an example system configured to facilitate agreements between parties, in accordance with one or more embodiments of the present disclosure.

FIG. 7 is a flow chart of an example method of generating an agreement, in accordance with one or more embodiments of the present disclosure.

### DETAILED DESCRIPTION

Legal agreements and/or contracts are important in various aspects of personal, professional and/or business interactions. The agreements may provide a formalized understanding between parties, establishing clear terms and expectations. For the agreements to be enforceable, and for the parties to be protected, certain requirements may be required for the agreements. For instance, certain formalities and/or clauses may be needed.

To ensure such requirements are met, the parties may use different services such as third-party services. However, such processes may be expensive and/or slow. For instance, use of third-party services (e.g., legal counsel) in contract formation may be time consuming and expensive, particularly as the terms of the contract gets complicated and/or long.

Alternatively, the parties may use pre-generated templates to generate the agreements. The pre-generated templates may include generalized contracts that the parties may use to form the agreements. For instance, the pre-generated templates may allow the parties to fill in the blanks with specific terms of the agreement without having to create the entire agreement from scratch. Additionally, the pre-generated templates may include general language that may help with enforceability of the agreements. However, use of such templates may be limited in usage. For example, without legal oversight, the parties may not fully understand the terms of the contracts. Additionally, it may be difficult for the parties to customize the templates to fit the needs of the parties, while ensuring that legal requirements are still met. Additionally, as modifications are made to the agreements, it may be difficult to keep track of different versions and/or changes.

According to one or more embodiments of the present disclosure, a system may be configured to facilitate agreements between parties. In particular, as described in detail in the present disclosure, the system may be configured such that the parties may create the agreements based on provided templates. The system may validate and/or verify the agreement to improve clarify and/or enforceability of the agreements. The system may further utilize blockchain such that the agreements may be properly recorded and/or stored.

In some circumstances, embodiments of the present disclosure may improve the operation of a computer and/or of related technologies. For example, a computing system such as a central server may work more efficiently, conserve computing resources, or operate more securely.

Embodiments of the present disclosure will be explained with reference to the accompanying drawings.

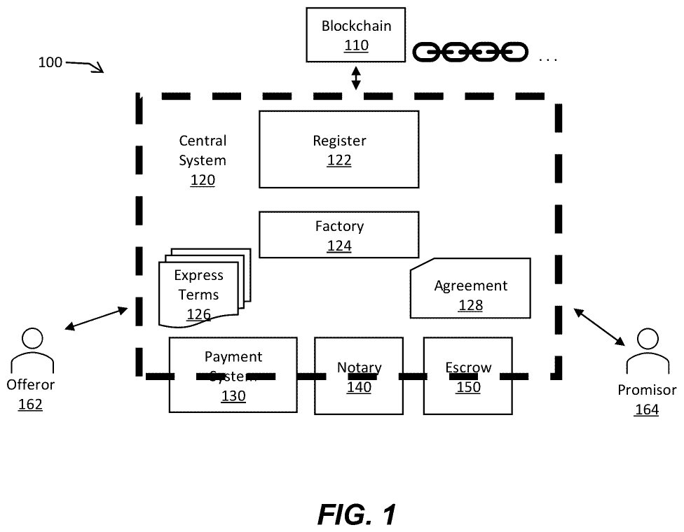

FIG. 1 is a diagram illustrating an example system 100 configured to operate as a blockchain-based system to facilitate agreements, in accordance with one or more embodiments of the present disclosure. In some embodiments, the system 100 may include a blockchain 110, a central system 120, a payment system 130 (which may or may not be part of the central system 120), a notary 140 (which may or may not be part of the central system 120), an escrow 150 (which may or may not be part of the central system 120), an offeror 162, and a promisor 164. The central system 120 may include a register 122, a factory 124, one or more express terms 126, and an agreement 128. While one agreement 128 is utilized as an example to facilitate discussion of the disclosure, it will be appreciated that any number of agreements may be created, facilitated, managed, or otherwise associated with the central system 120.

In some embodiments, the central system 120 may be configured to facilitate the agreement 128 between the offeror 162 and the promisor 164 (collectively referred to collectively as the parties), and the posting of the agreement 128 to the blockchain 110. For example, the offeror 162 and the promisor 164 may come to an understanding with a set of terms that may be found within the express terms 126. The central system 120 may facilitate the generation and signing of the agreement 128, the posting of the completed and signed agreement 128 to the blockchain 110, the receipt of payments from the promisor 164 into the escrow 150, the payment to the promisor 164, and/or other tasks or processes associated with the agreement 128.

The blockchain 110 may include any type of distributed ledger with a growing list of records (referred to as blocks) that are securely linked together via cryptographic hashes. Information may be submitted for publication to the blockchain 110, which may be validated by a set number of peers hosting one or more portions of (or entire copies of) the blockchain 110 before the information submitted in such a manner is posted to the blockchain 110. In some embodiments, the blockchain 110 may include one or more preexisting blockchain platforms, such as Polygon, Ethereum, Klaytn, Solana, Arbitrum, Optimism, Avalanche, Bitcoin, BNB chain, BNB smart chain, Gnosis, Astar, or Near, among others. While a single blockchain is illustrated, it will be appreciated that the central system 120 may be configured to interact with multiple blockchains. In some embodiments, the blockchain 110 may include a Polygon blockchain operating in conjunction with the main Ethereum blockchain.

While the example system 100 is shown in FIG. 1 as operating off the blockchain 110 to facilitate discussion of the disclosure, it will be appreciated that any number of the elements, components, or processes occurring within the example system 100 may be implemented on or posted to the blockchain 110. For example, the negotiations to arrive at the agreement 128 may be posted to the blockchain 110. As another example, the express terms 126 may be posted to the blockchain 110.

In some embodiments, the central system 120 may be configured to communicate across multiple blockchains, including the blockchain 110. For example, the central system 120 may be configured to validate one or more pieces of information on a blockchain different than the blockchain 110 to which the central system 120 is configured to post blocks. For example, the central system 120 may be configured to validate ownership of an asset (such as a non-fungible token (NFT) or a trademark right). As another example, the central system 120 may be configured to validate ownership of funds in a wallet, verify the occurrence of transactions, or post blocks to other blockchains separate from the blockchain 110. In some embodiments, any or all of the components of the central system 120 may be implemented on the blockchain 110 including the register 122, the express terms 126, the factor 124, the agreement 128, the payment system 130, the notary 140, and/or the escrow 150.

In some embodiments, the express terms 126 may include one or more specific provisions associated with potential agreements. In some embodiments, the express terms 126 may be represented as a text string or vector of information that includes a particular provision of a contract or other agreement. In some embodiments, a customer of the central system 120 (e.g., the offeror 162) may provide one or more provisions to be included in the express terms 126 as a preliminary matter, such as when first setting up a system or offering materials in a marketplace. Additionally or alternatively, the express terms 126 may include terms or provisions added later and/or that are customized. For example, a vast majority of agreements for the offeror 162 may be the same, but certain agreements may utilize customized or personalized terms. In these and other embodiments, the offeror 162 may provide or supplement the express terms 126 with additional terms at any point in time. Additionally or alternatively, the offeror 162 may permit the promisor 164 to submit terms or provisions to the express terms 126.

In some embodiments, the express terms 126 may include one or more placeholder data structures that may be supplemented when the agreement 128 is formed to include a given express term. For example, a given express term may include a placeholder within which a dollar amount agreed to by the parties, a date, a time, a duration of the agreement, a name of a party, a signature of a party, or any other field of information may be included in the given express term.

The agreement 128 may include any agreement between the offeror 162 and the promisor 164, such as mutually agreed upon conditions, performances, payments, exchanges of goods or services, or any other agreed-to conditions. In some embodiments, the agreement 128 may include at least one of the express terms 126. In some embodiments, the agreement 128 is made entirely of the express terms 126 which are supplemented with fillable information or other supplemental information such as names and/or contact information of parties, etc. In some embodiments, the agreement 128 may include the exchange of a right to use a non-fungible token (NFT) in exchange for monetary remuneration (whether a single lump sum payment or periodic payments). In some embodiments, the agreement 128 may include the exchange of a right to use a registered trademark for a certain class or classes of goods or services in exchange for monetary remuneration (whether a single lump sum payment or periodic payments).

In some embodiments, the agreement 128 may be represented by a series of data pointers or hashed values corresponding to known elements of the express terms 126 with supplementing information and/or encrypted or hashed values thereof.

In some embodiments, the factory 124 may facilitate formation of the agreement 128. For example, the factory 124 may act as an application programming interface (API) or other set of software operations that may receive a set of identified terms (such as a group of terms from the express terms 126) and may compile the terms into a formalized agreement. Additionally or alternatively, the factory 124 may facilitate receiving signatures from each of the offeror 162 and the promisor 164. For example, the factory 124 may send a copy of the agreement 128 with completed terms but without the accompanying signatures to each of the offeror 162 and the promisor 164. In response, the offeror 162 and/or the promisor 164 may sign the agreement 128. This may include electronically signing the agreement 128 and/or providing a physical signature that is conveyed to the central system 120, whether electronically or physically.

In some embodiments, the factory 124 may communicate with a respective electronic device of the offeror 162 and/or the promisor 164. For example, the agreement 128 may be sent to a known electronic address (e.g., email address, ftp link, etc.). Additionally or alternatively, the agreement 128 may be formed while the offeror 162 and/or the promisor 164 may remain anonymous. For example, a wallet ID or other electronic identifier that does not convey the actual identity of a given party may be used as the address or identifier for the agreement 128.

In some embodiments, when seeking a signature (or in other communications regarding the agreement 128), the factory 124 may invoke a know your customer (KYC) authentication. For example, a third-party service may be invoked by the factory 124 to validate the identity of the offeror 162 and/or the promisor 164 before they are permitted to submit a signature for the agreement 128. Additionally or alternatively, the third-party and/or the factory 124 may verify the identity associated with an electronic wallet or other electronic identifier and a hash of the authentication or other trusted, encrypted approval may be included in conjunction with or in place of the signature. In some embodiments, the identifier associated with the agreement 128 may include an electronic wallet, such as a wallet associated with a given cryptocurrency such as Ethereum, Bitcoin, or any other digital currency.

In some embodiments, upon compiling information into a completed form of the agreement 128 (e.g., all terms included in the agreement 128, all parties' signatures included in the agreement 128, etc.), the factory 124 may provide the agreement 128 to the register 122. The register 122 may include a system, hardware, software, set of operations, programing code, or other components configured to facilitate the performance by the central system 120 of the described operations. In these and other embodiments, the register 122 may facilitate the posting of the agreement 128 to the blockchain 110. For example, the register 122 may provide the agreement 128, an encrypted form of the agreement 128, a hash value of the agreement 128, or some other set of data related to the agreement 128 to be posted to the blockchain 110.

In some embodiments, the factory 124 may be configured to validate or verify aspects of the agreement 128 prior to posting the agreement 128 to the blockchain 110. For example, the factory 124 may be configured to verify that the agreement 128 has been properly executed and/or otherwise signed by the offeror 162 and/or the promisor 164. In these and other embodiments, the factory 124 may be configured to validate or verify aspects of the agreement 128 on the blockchain 110.

The payment system 130 may include any entity, system, or component configured to facilitate the receipt and or distribution of payments from one entity to another. In some embodiments, the payment system 130 may include a system that interfaces with the blockchain 110 and/or another cryptocurrency blockchain to observe, confirm, and/or record blocks on the blockchain representative of transfer of digital assets. In some embodiments, the payment system 130 may configure an automated transfer of assets in a manner to be consistent with the agreement 128. For example, the payment system 130 may be configured to verify that an agreed-to amount of cryptocurrency is received from the promisor 164 into an account or wallet associated with the escrow 150 prior to a given date identified in the agreement 128. Additionally or alternatively, the payment system 130 may be configured to extract, process, relay, or otherwise provide a transfer of digital assets from the escrow 150 to the offeror 162. For example, the payment system 130 may write a transaction to the blockchain 110 that includes a transfer of the agreed-to amount of cryptocurrency from a wallet associated with the escrow 150 to a wallet associated with the offeror 162.

In some embodiments, the payment system 130 may be customizable and configurable to reflect the express terms 126 included in the agreement 128. For example, the payment system 130 may be configured to facilitate a one-time lump sum payment, periodic payments (e.g., payments once per month, once per quarter, twice per year, once per year, etc.), event-triggered payments, or any other structure or format of transfer of assets. As another example, the payment system 130 may be configured to facilitate differing payment amounts (e.g., an amount reflective of a current valuation of the cryptocurrency, an amount reflective of a number of units sold, an amount reflective of a percentage of profits, or any other customizable or agreed-to amount). In some embodiments, the offeror 162 may utilize a standardized software development kit (SDK) to configure the payment system 130 to reflect the preferred method of payment for the offeror 162.

In some embodiments, the various agreements may or may not involve the exchange of a digital asset between the parties. For example, the agreement 128 may include the exchange of agreed-upon services without any remuneration. In these and other embodiments, the payment system 130 may be omitted from or not be utilized in a given circumstance or example use of the system 100. For example, where there is no financial component or exchange of payment between the offeror 162 and the promisor 164, the payment system 130 may not be included in the example system 100. In some embodiments, the payment system 130 may be unused, dormant, or otherwise inactive in the example system 100. In these and other embodiments, for an existing agreement 128 and an update or revision thereto, the payment system 130 may be activated where the express terms 126 in the updated agreement 128 include a payment term or other financial component.

In some embodiments, the notary 140 may include an off-chain entity, system, or component configured to facilitate communication between the offeror 162 and the promisor 164. For example, the notary 140 may represent a trusted third party between which the offeror 162 and the promisor 164 may exchange terms, redline terms, submit signatures, or otherwise communicate prior to the formation of the agreement 128 or after formation of the agreement 128. In these and other embodiments, the notary 140 may be a part of the central system 120 or may be a separate entity or computing device. In some embodiments, the notary 140 may include a database or other off-chain storage repository in which various information related to the agreement 128 may be stored off of the blockchain 110 but in a manner that may be recalled later if desired and may be identified as being associated with the agreement 128 even after the agreement 128 is posted to the blockchain 110.

In some embodiments, the notary 140 may include an on-chain entity, system, or component configured to facilitate communication between the offeror 162 and the promisor 164. For example, the notary 140 may represent a trusted third party between which the offeror 162 and the promisor 164 may exchange terms, redline terms, submit signatures, or otherwise communicate prior to the formation of the agreement 128 or after formation of the agreement 128. In some embodiments, the notary 140 may natively encrypt the redlining, negotiations, or other communications prior to the formation of the agreement 128 or after formation of the agreement 128 to one or more blocks in the blockchain 110 such that the communications are immutable. In these and other embodiments, the notary 140 may be a part of the central system 120 or may be a separate entity or computing device.

In some embodiments, the factory 124 may operate in conjunction with the notary 140 to perform one or more of the tasks described as being associated with the factory 124. For example, the notary 140 may be configured to provide a service or system via which the offeror 162 and/or the promisor 164 are able to confirm their identity when signing an agreement as requested by the factory 124. As another example, the notary 140 may act as a communication interface with which the offeror 162 and/or the promisor 164 provide documentation to prove their identity (e.g., passports, social security identification cards, driver's licenses, among others). In some embodiments, the notary 140 may be a separate entity from the factory 124 and may provide a trusted proof of the identity of one of the offeror 162 and/or the promisor 164 to the factory 124, such as providing a hash value of a proof of identity.

The escrow 150 may include a wallet, an account, a financial system, or any other component configured to receive and hold assets (including, for example, cryptocurrency, digital currency, or any other electronic asset) during a transaction. For example, the escrow 150 may be configured to receive cryptocurrency funds from the promisor 164 into a wallet associated with the escrow 150 in conjunction with the agreement 128. Upon completion of the agreement 128 or upon performance of a given express term of the agreement 128, the agreed-to asset in the escrow 150 may be transferred to the offeror 162, such as by posting a block to a blockchain that transfers the agreed-to asset from the wallet associated with the escrow 150 to the wallet associated with the offeror 162.

Modifications, additions, or omissions may be made to the system 100 without departing from the scope of the disclosure. For example, the designations of different elements in the manner described is meant to help explain concepts described herein and is not limiting. As another example, the system 100 may include any number of other elements or may be implemented within other systems or contexts than those described.

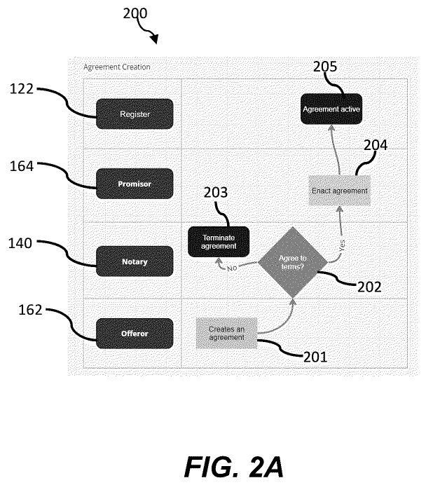

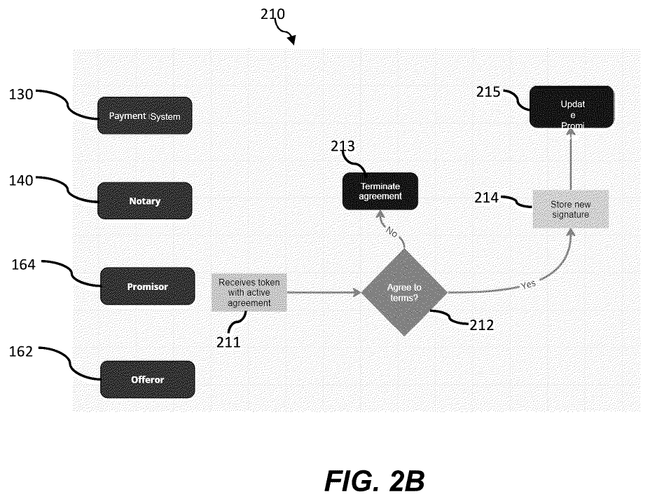

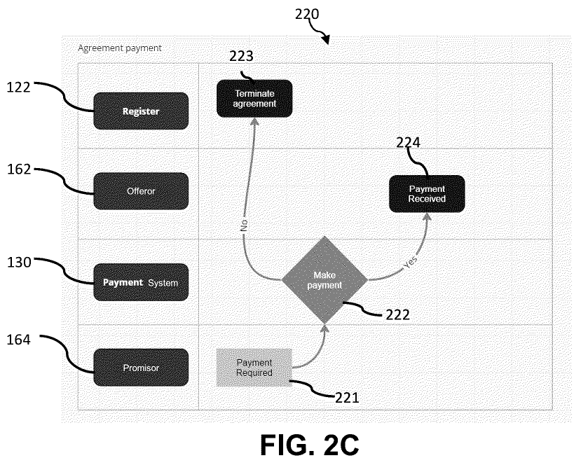

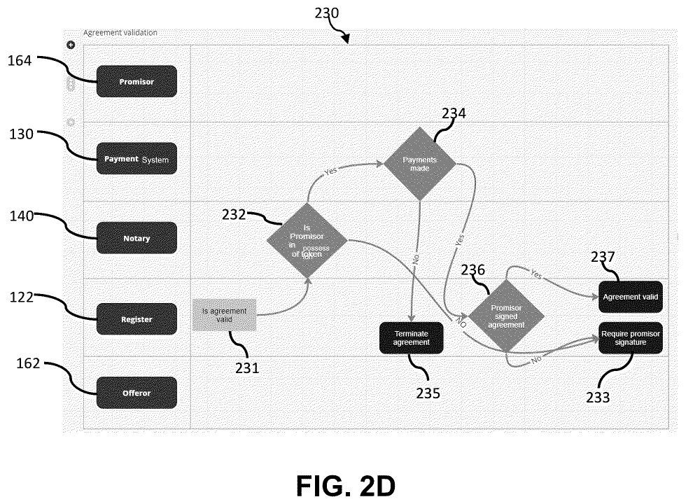

FIGS. 2A-2D illustrate various workflows executed by a system such as the example system 100. FIG. 2A illustrates an agreement creation workflow 200 executed by the example system 100. FIG. 2B illustrates an asset transfer workflow 210 executed by the example system 100. FIG. 2C illustrates an agreement payment workflow 220 executed by the example system 100. FIG. 2D illustrates an agreement validation workflow 230 executed by the example system 100. One or more operations of the workflows 200, 210, 220, and 230 may be performed by a system or a device, or combinations thereof, such as the system 100, the offeror 162, the promisor 164, and/or the components of the central system 120 including the register 122, the factory 124, the payment system 130, the notary 140, and/or the escrow 150. Although illustrated as discrete blocks, various blocks of the workflows 200, 210, 220, and 230 may be divided into additional blocks, combined into fewer blocks, or eliminated, depending on the implementation.

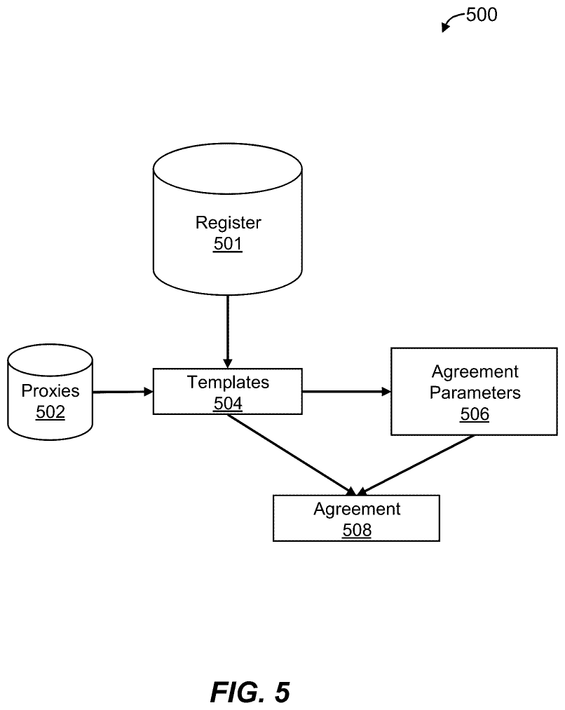

While the workflows 200, 210, 220, and 230 are described with reference to the example system 100 of FIG. 1, which illustrates the components of the example system 100 off of the blockchain 110 to facilitate discussion of the disclosure, it will be appreciated that any of the workflows 200, 210, 220, and 230 may take place on the blockchain 110. For example, the agreement payment workflow 220 may take place on the blockchain 110. Although the workflows are 200, 210, 220, and 230 are described with reference to the example system 100 of FIG. 1, any or all of the workflows could be implemented by the example system 500 of FIG. 5.

FIG. 2A illustrates a swim lane diagram of the agreement creation workflow 200 executed by the example system 100. The agreement created in the agreement creation workflow 200 may be the agreement 128 of FIG. 1.

At block 201, the agreement creation workflow 200 determines that the offeror 162 has created an agreement. The offeror 162 may create an agreement in the example system 100, which may include the express terms 126. In some embodiments, the agreement may be a trademark licensing agreement or other intellectual property licensing agreement. For example, the offeror 162 may create a licensing agreement which allows the offeror 162 to use the trademarks of the promisor 164 in conjunction with specific commercial items. In some embodiments, the agreement may grant rights to use a token. For example, the agreement may grant the right to publicly display or otherwise use an NFT. The created agreement may then be sent to the notary 140.

At block 202, the notary 140 may determine whether the promisor 164 agrees to the terms of the created agreement. For example, the notary 140 may verify the identity of the promisor 164 and/or receive a signature from the promisor 164. If the promisor 164 agrees to the terms, then the agreement creation workflow 200 may move to block 203. If the promisor 164 does not agree to the terms, then the agreement creation workflow 200 may move to block 204.

At block 203, the notary 140 may terminate the agreement if the promisor 164 does not agree to the terms. For example, the promisor 164 may reject a trademark use agreement because the promisor 164 does not wish to associate their mark with a specific industry in which the offeror 162 intends to use the mark, and the notary 140 may terminate the agreement. In some embodiments, after the agreement is terminated the notary 140 may send the agreement back to the offeror 162 and notify the offeror 162 of any potential redlines or terms objected to by the promisor 164.

At block 204, the promisor 164 may enact, countersign, or otherwise approve the agreement. For example, the promisor 164 may agree with the terms of a trademark use agreement and enact the agreement. The system 100 may mark the enacted agreement as executed and may send the enacted agreement to the register 122.

At block 205, the register 122 may mark the agreement as active in the system 100. For example, once the promisor 164 and the offeror 162 have agreed to the terms of a trademark agreement and the agreement has been enacted, the agreement may be placed on the register 122 and marked as active. The register 122 may then place the active agreement on the blockchain 110.

FIG. 2B illustrates a swim lane diagram of the asset transfer workflow 210 executed by the example system 100. The agreement in the asset transfer workflow 210 may be the agreement 128 of FIG. 1.

At block 211, the asset transfer workflow 210 may determine that the promisor 164 received a token that may be subject to an active agreement with the offeror 162. In some embodiments, the token may be a non-fungible token (NFT). In some embodiments, the promisor 164 may receive other assets such as trademarks or other intellectual property that may be subject to an active agreement with the offeror 162. For example, the promisor 164 may receive a Bored Ape NFT where a preceding promisor had entered into a use agreement with the offeror 162, and that use agreement may be active when the promisor 164 receives the Bored Ape NFT.

At block 212, the promisor 164 may opt in or opt out of the active agreement associated with the received token. If the promisor 164 decides to opt out of the active agreement, then the asset transfer workflow 210 moves to block 213. If the promisor 164 decides to sign the agreement and/or opt into the agreement, then the asset transfer workflow moves to block 214.

At block 213, the notary 140 may terminate the active agreement if the promisor 164 opts out of the agreement at block 212. For example, the promisor 164 may want to use or otherwise display the Bored Ape NFT in a public setting, but the active agreement that was previously agreed to may preclude public display of the token. Hence, the promisor 164 may opt out of the existing agreement, and the notary 140 may terminate the agreement. Terminating the agreement may return the Bored Ape NFT to the original offeror.

At block 214, the notary 140 may store a new signature of the promisor 164, which may indicate assent to the active agreement associated with the token. For example, the promisor 164 may receive a Bored Ape NFT with an active agreement prohibiting public display, the promisor 164 may agree to the active agreement by signing the agreement, and the notary 140 may store the new signature of the promisor 164.

At block 215, the payment system 130 may update the promisor 164. For example, the payment system 130 may update the system 100 with the identifying characteristics of the promisor 164 who agreed to the terms of the Bored Ape Token in preceding examples.

FIG. 2C is a swim lane diagram illustrating the agreement payment workflow 220 executed by the example system 100. The agreement in the agreement payment workflow 220 may be the agreement 128 of FIG. 1.

At block 221, the agreement payment workflow 220 may indicate that the promisor 164 is required to make a payment pursuant to the active agreement. In some embodiments, the promisor 164 may be alerted, informed, or otherwise notified that a payment is required. Additionally or alternatively, the payment may be made automatically through funds placed in the escrow 150 of FIG. 1. For example, the promisor 164 and the offeror 162 may have entered into an agreement where the promisor 164 licenses the trademark of the offeror 162 for a specific good, and the promisor 164 is obligated to pay quarterly royalty payments. When the payment from the preceding example is due, block 221 indicates that a quarterly royalty payment is required.

At block 222, the payment system 130 may determine whether a payment has been made by the promisor 164. If a payment has not been made, the agreement payment workflow 220 moves to block 223. If a payment has been made, the agreement payment workflow 220 moves to block 224.

At block 223, the agreement in the register 122 may be terminated if a determination has been made by the payment system 130 that the promisor 164 has not made a payment in compliance with the active agreement. For example, the promisor 164 may default on quarterly royalty payments under a trademark licensing agreement, and the agreement may be terminated in the register 122.

At block 224, the offeror 162 may receive payment from the promisor 164. For example, the promisor 164 may transfer an asset such as cryptocurrency to an escrow (such as the escrow 150), which may be provided from the escrow to the offeror. For example, the offeror 162 may receive a quarterly royalty payment under a trademark licensing agreement if the payment system 130 has determined that a payment has been made by the promisor 164 into the escrow. Where the offeror 162 receives payment, the agreement may remain active.

FIG. 2D is a swim lane diagram illustrating the agreement validation workflow 230 executed by the example system 100. The agreement in the agreement validation workflow 230 may be the agreement 128 of FIG. 1.

At block 231, the agreement validation workflow 230 may prompt the register 122 to inquire into the validity of an agreement. For example, the register 122 may periodically work to clean up older potentially invalid agreements, or may respond to a query regarding the validity of an agreement, or for any other purpose.

At block 232, the notary 140 may determine whether the promisor 164 is in possession of the token associated with the agreement in question. For example, the notary 140 may determine whether the promisor 164 is in possession of a Bored APE NFT. If the notary 140 determines that the promisor 164 is not in possession of the token, the agreement validation workflow 230 moves to block 233. If the notary 140 determines that the promisor 164 is in possession of a token, the agreement validation workflow 230 moves to block 234.

At block 233, the register 122 may require the signature of the promisor 164 because the notary 140 has determined, at block 232, that the promisor 164 is not yet in possession of the token associated with the agreement. For example, the register 122 may require the signature of the promisor 164 if the notary 140 determines that the promisor 164 is not in possession of the Bored Ape NFT.

At block 234, the payment system 130 may determine whether the agreed-to payment(s) have been made by the promisor 164. If the agreed-to payment(s) have not been made, the agreement validation workflow 230 moves to block 235. If the agreed-to payment(s) have been made, the agreement validation workflow 230 moves to block 236.

At block 235, the agreement at issue may be terminated based on the determination that the promisor 164 has not made the agreed-to payment(s) in compliance with the active agreement. For example, the promisor 164 may default on quarterly royalty payments under a trademark licensing agreement, and the agreement may be terminated. In some embodiments, after an agreement is terminated, the register 122 may post a new block to the blockchain 110 indicating that the agreement is terminated.

At block 236, the register 122 may determine if the promisor 164 has signed the agreement. If the promisor 164 has not signed the agreement, the agreement validation workflow 230 moves to block 233. If the promisor 164 has signed the agreement, the agreement validation workflow 230 moves to block 237.

At block 233, the register 122 may require the signature of the promisor 164 because the register 122 has determined, at block 236, that the promisor 164 has not signed the agreement. For example, the register 122 may require the signature of the promisor 164 if the register 122 determines that the promisor 164 has not signed a trademark licensing agreement.

At block 237, the register 122 may validate the agreement after determining that the promisor 164 has signed the agreement. For example, the register 122 may validate a trademark licensing agreement after determining that the promisor 164 has signed the agreement.

Modifications, additions, or omissions may be made to the workflows 200, 210, 220, and 230 without departing from the scope of the disclosure. For example, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

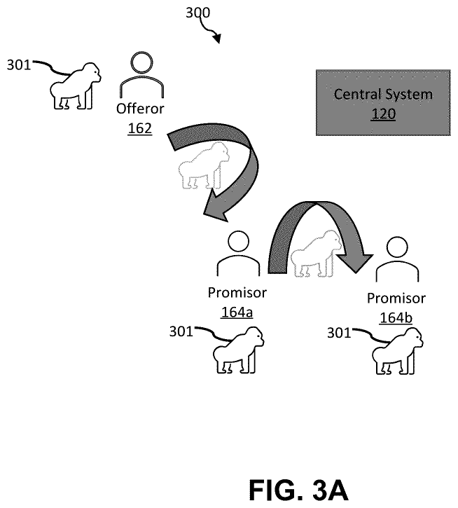

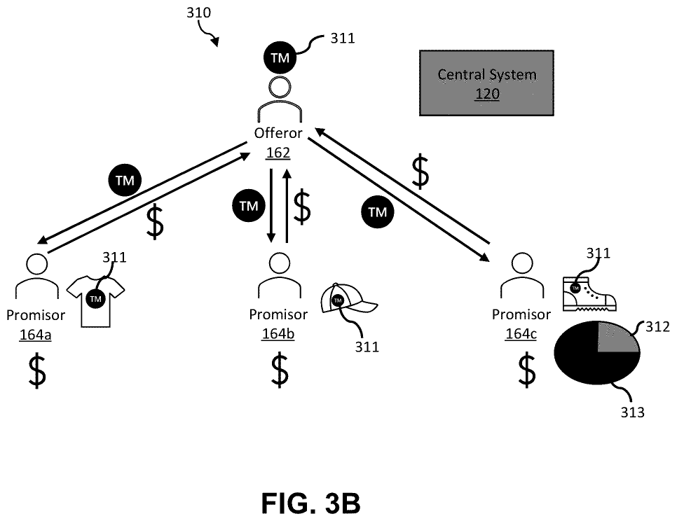

FIG. 3A illustrates use of the example system 100 and the workflows 200, 210, 220, and 230 in the context of an intellectual property marketplace 300. In operation, the offeror 162 may own intellectual property 301 and may sell or grant rights in the intellectual property 301 to a first promisor 164a pursuant to an agreement between the two parties. In these and other embodiments, a first promisor 164a may sell or grant use of the intellectual property 301 to a second promisor 164b. The second promisor 164b may have the option to opt in or opt out of the active agreement associated with the intellectual property 301. The second promisor 164b may then sell to a third promisor (not illustrated) and so on. In some embodiments, the intellectual property 301 may be a patent, copyright, trademark, non-fungible token, rights of publicity (e.g., Name, Image, and Likeness rights), or other intellectual property. For example, the intellectual property 301 may be a Bored Ape NFT. Each transaction in the intellectual property marketplace 300 and the transaction's associated negotiations may be recorded and placed on the blockchain 110 and/or stored in a database associated with the central system 120.

In some embodiments, the intellectual property marketplace 300 may trigger real time alerts, messages, or other notifications to the promisor 164 and/or the offeror 162. In these and other embodiments, the notifications may be sent to the promisor 164 and/or the offeror 162 based on events including party signatures, agreement termination, asset transfers, transferee opt in or opt out, payments, defaults, or other events.

In some embodiments, the offeror 162 may create the agreement 128 to sell or grant rights in the intellectual property 301 to a promisor 164. In some embodiments, the agreement creation in the intellectual property marketplace 300 may utilize the agreement creation workflow 200. In these and other embodiments, the agreement 128 may also include express terms 126. For example, the offeror 162 may offer a Bored Ape NFT for sale but may include express terms 126 requiring that the offeror 162 be compensated with royalties from future use of the Bored Ape NFT. In some embodiments, the promisor 164 may agree to the express terms 126 regarding the intellectual property 301 upon which the offeror 162 may have conditioned the agreement 128. In these and other embodiments, the agreement 128 may be enacted and placed in the register 122 as active. For example, the promisor 164 may agree to pay the offeror 162 royalties based on future use of the intellectual property 301. In some embodiments, the promisor 164 may not agree to the express terms 126 placed upon the intellectual property 301, and the agreement 128 may be terminated. In some embodiments, negotiations regarding the sale of the intellectual property 301 may be recorded in a database and an identifier associated therewith identifies a block, agreement, or information related to the agreement that is placed on the blockchain 110 when the agreement becomes active in the register 122. For example, the offeror 162 and the promisor 164 may negotiate the royalty percentage regarding future sales of intellectual property 301 down from 10% of sales to 8% of sales, and all of the negotiations to reach the agreed upon percentage may be recorded and placed in the database and linked to or otherwise associated with the agreement 128 posted to the blockchain 110.

In some embodiments, payments for the intellectual property 301 in the intellectual property marketplace 300 may be due at the initial agreement and/or payments may be due throughout the life of the agreement 128. In these and other embodiments, payments for the intellectual property 301 from the promisor 164 to the offeror 162 in the intellectual property marketplace 300 may utilize the agreement payment workflow 220. In embodiments where payment is not received for the intellectual property 301, the agreement payment workflow 220 may terminate the agreement 128. In embodiments where payment is received for the intellectual property 301, the agreement payment workflow 220 may determine that payment has been received and the agreement 128 will remain active. For example, the first promisor 164a may agree to pay a quarterly 8% royalty on use of the intellectual property 301, and when the quarterly payment becomes due, the agreement payment workflow 220 may be initiated.

In some embodiments, upon sale or transfer of the underlying intellectual property 301, the second promisor 164b may have the opportunity to opt into or opt out of the active agreement 128 between the first promisor 164a and the offeror 162. In these and other embodiments, transfers of intellectual property 301 subject to an active agreement in the intellectual property marketplace 300 may follow the asset transfer workflow 210. For example, the first promisor 164a may transfer intellectual property 301 subject to an active royalty agreement to the second promisor 164b, and this transfer may initiate the asset transfer workflow 210. In some embodiments, when the second promisor 164b receives the intellectual property 301, the second promisor 164b may agree to the express terms 126 in the agreement 128, and the payment system 130 may update the second promisor 164b to be the promisor 164 obligated to pay. For example, the second promisor 164b may receive intellectual property 301 subject to the active agreement 128 regarding royalties on future use between the first promisor 164a and the offeror 162, and the second promisor 164b may agree to the royalty percentage on future use. In embodiments where the second promisor 164b agrees to the express terms 126, then the agreement 128 associated with the underlying intellectual property 301 may continue until the designated end of the contract or until some other terminating event occurs. In some embodiments, when the second promisor 164b receives the intellectual property 301, the second promisor 164b may not agree to the express terms 126 in the agreement 128, and the agreement 128 may be terminated and/or rendered null and void. In these and other embodiments, the agreement creation workflow 200 may be initiated so that the second promisor 164b may negotiate a new agreement 128 regarding the intellectual property 301 with the offeror 162.

In some embodiments, agreements 128 in the intellectual property marketplace 300 may follow the agreement validation workflow 230. For example, an agreement between the offeror 162 and the promisor 164 regarding the use of a Bored Ape NFT may follow the agreement validation workflow 230.

Although described with reference to the example system 100, the intellectual property marketplace 300 may be implemented by the system 500 of FIG. 5.

FIG. 3B illustrates use of the example system 100 and the workflows 200, 210, 220, and 230 in the context of a community trademark marketplace 310. In operation, the community trademark marketplace 310 may allow a trademark holder such as an offeror 162 to license out a trademark 311 to one or more promisors 164 subject to agreements regarding the trademark 311. In some embodiments, the trademark 311 may be a registered trademark (foreign or domestic) or the trademark 311 may be an unregistered trademark (common-law trademark). In some embodiments, the promisor 164 may be given, by the offeror 162, the agreement 128 and a questionnaire in which the promisor 164 may outline their intended use of the trademark 311 or what product the promisor 164 plans on using the trademark 311 in conjunction with. In these and other embodiments, the questionnaire may be submitted along with the signed agreement 128 to the offeror 162, and if the offeror 162 signs the agreement 128, the promisor 164 may receive the trademark 311. In some embodiments, when the promisor 164 receives the trademark 311 the promisor 164 may be obligated to pay the offeror 162 an initial licensing fee.

In some embodiments, the offeror 162 may license the trademark 311 to one promisor 164. In these and other embodiments, the offeror 162 may license the trademark 311 to multiple promisors such as promisor 164a-c. In some embodiments, the offeror 162 may license the trademark 311 for specific uses, and the offeror 162 may prohibit other uses of the trademark 311. For example, the offeror 162 may license the trademark 311 to the promisor 164a to be used in connection with t-shirt sales, the offeror 162 may license the trademark 311 to the promisor 164b to be used in connection with hat sales, and the offeror 162 may license the trademark 311 to the promisor 164c in connection with shoe sales. Further, in the agreements 128 with the promisors 164a-c, the offeror 162 may prohibit use of the trademark 311 in connection with tobacco products. In embodiments where the promisor 164 uses the trademark 311 in a prohibited manner, the agreement 128 may terminate.

In some embodiments, the agreement 128 between the offeror 162 and the promisor 164 may designate approved areas 312 for use of the trademark 311, and the agreement 128 may also designate unapproved areas 313 for use of the trademark 311. For example, the agreement may permit use of the trademark 311 by the promisor 164c in approved areas 312 where the promisor 164c does not compete with the offeror 162, and the agreement 128 may prohibit use of the trademark 311 by the promisor 164c in unapproved areas 313 where the promisor 164c is in competition with the offeror 162. In some embodiments, approved areas 312 and unapproved areas 313 may be customized as express terms 126. In these and other embodiments, approved areas 312 and unapproved areas 313 may be a default list of industries, sectors, markets, or other relevant segments of the economy. Additionally or alternatively, approved areas 312 and unapproved areas 313 may be determined from the questionnaire submitted by the promisor 164. In embodiments where the promisor 164 uses the trademark 311 in the unapproved areas 313, the agreement 128 may terminate.

In some embodiments, the offeror 162 may create the agreement 128 to license the trademark 311 to a promisor 164. In some embodiments, the agreement creation in the community trademark marketplace 310 may utilize the agreement creation workflow 200. In these and other embodiments, the agreement 128 may also include express terms 126. For example, the offeror 162 may license a trademark 311 but may include express terms 126 requiring that the offeror 162 be compensated with royalties from all sales of merchandise using the trademark 311 along with an initial licensing fee. In some embodiments, the promisor 164 may agree to the express terms 126 regarding the trademark 311 upon which the offeror 162 may have conditioned the agreement 128. In these and other embodiments, the agreement 128 may be enacted and placed in the register 122 as active. For example, the promisor 164 may agree to pay the offeror 162 an initial licensing fee of the trademark 311 along with royalties on all merchandise utilizing the trademark 311. In some embodiments, the promisor 164 may not agree to express terms 126 placed upon the trademark 311 and the agreement 128 may be terminated. In some embodiments, the negotiations regarding use of the trademark 311 may be recorded in a database and the agreement 128 may be placed on the blockchain 110 by the register 122 when the agreement 128 becomes active. For example, the offeror 162 and the promisor 164 may negotiate the royalty percentage regarding merchandise sales using the trademark 311 down from 10% of sales to 8% of sales, and all of the negotiations to reach the agreed upon percentage may be recorded and placed in the database and linked to or otherwise associated with the agreement 128 posted to the blockchain 110.

In some embodiments, payments for use of the trademark 311 may be due at the initial agreement and/or payments may be due throughout the life of the agreement 128. In these and other embodiments, payments from the promisor 164 to the offeror 162 for use of the trademark 311 may utilize the agreement payment workflow 220. In embodiments where payment is not received for use of the trademark 311, the agreement payment workflow 220 may terminate the agreement 128. In embodiments where payment is received for use of the trademark 311, the agreement payment workflow 220 may determine that payment has been received and the agreement 128 will remain active. For example, the promisor 164 may agree to pay an 8% royalty on future sales of merchandise using the trademark 311 which may be due quarterly, and when the payment becomes due, the agreement payment workflow 220 may be initiated and payment may be required.

In some embodiments, upon sale or transfer of the rights to use the trademark 311, the purchasing promisor 164 may have the opportunity to opt into or opt out of the active agreement 128 between the selling promisor 164 and the offeror 162. In these and other embodiments, transfers of rights to use the trademark 311 may follow the asset transfer workflow 210. For example, the selling promisor 164 may transfer the rights to use the trademark 311 to a purchasing promisor 164, and this transfer may initiate the asset transfer workflow 210. In some embodiments, when the purchasing promisor 164 receives the trademark 311 use rights, the purchasing promisor 164 may agree to the express terms 126 in the agreement 128, and the payment system 130 may update the promisor 164. In embodiments where the purchasing promisor 164 agrees to the express terms 126, then the agreement 128 associated with the underlying trademark 311 may continue until the designated end of the contract or until some other terminating event occurs. For example, the agreement 128 may terminate if the purchasing promisor 164 begins to use the trademark 311 in a prohibited manner, the offeror 162 may notify the central system 120 of the breach of the agreement and may request termination of the agreement 128. In some embodiments, when the purchasing promisor 164 receives the trademark 311 use rights, the purchasing promisor 164 may not agree to the express terms 126 in the agreement 128, and the agreement 128 may be terminated and/or rendered null and void. In these and other embodiments, the agreement creation workflow 200 may be initiated so that the purchasing promisor 164 may negotiate a new agreement 128 regarding use of the trademark 311 with the offeror 162.

In some embodiments, agreements 128 in the community trademark marketplace 310 may follow the agreement validation workflow 230. For example, the agreement 128 between the offeror 162 and the promisor 164 regarding the use of trademark 311 may follow the agreement validation workflow 230.

Although described with reference to the example system 100, the community trademark marketplace 310 may also be implemented by the system 500 of FIG. 5.

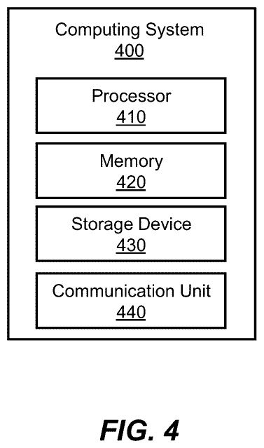

FIG. 4 illustrates an example computing system 400, according to at least one embodiment described in the present disclosure. The computing system 400 may include a processor 410, a memory 420, a storage device 430, and/or a communication unit 440, which all may be communicatively coupled. Any or all of the system 100 of FIG. 1 may be implemented as a computing system consistent with the computing system 400, such as the blockchain 110, the payment system 130, the notary 140, the escrow 150, the offeror 162, the promisor 164, and/or any of the components of the central system 120 including the register 122, the factory 124, the express terms 126, and the agreement 128. For example, the promisor 164 may perform operations using an electronic device consistent with the computing system 400. As another example, the blockchain 110 may be stored and/or verified across multiple instantiations of a computer consistent with the computing system 400. Any or all of the workflows 200, 210, 220, or 230 of FIGS. 2A-2D respectively may be implemented as a computing system consistent with the computing system 400. Any or all of the system 500 of FIG. 5 may be implemented as a computing system consistent with the computing system 400, such as the register 122, the payment system 130, the notary 140, and/or the escrow 150.

Generally, the processor 410 may include any computer, computing entity, or processing device including various computer hardware or software modules and may be configured to execute instructions stored on any applicable computer-readable storage media. For example, the processor 410 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 4, it is understood that the processor 410 may include any number of processors distributed across any number of network or physical locations that are configured to perform individually or collectively any number of operations described in the present disclosure. In some embodiments, the processor 410 may interpret and/or execute program instructions and/or process data stored in the memory 420. In some embodiments, the processor 410 may load the program instructions into the memory 420.

After the program instructions are loaded into the memory 420, the processor 410 may execute the program instructions, such as instructions to perform any or all of the workflows 200, 210, 220, or 230 of FIGS. 2A-D, respectively. For example, the processor 410 may obtain instructions regarding facilitating the asset transfer workflow 210.

The memory 420 and the storage device 430 may include computer-readable storage media or one or more computer-readable storage mediums for carrying or having computer-executable instructions or data structures stored thereon. Such computer-readable storage media may be any available media that may be accessed by a computer, such as the processor 410. For example, the memory 420 and/or the storage device 430 may store a complete copy of a blockchain (such as the blockchain 110 of FIG. 1). In some embodiments, the computing system 400 may or may not include either of the memory 420 and/or the storage device 430.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures. Combinations of the above may also be included within the scope of computer-readable storage media. Computer-executable instructions may include, for example, instructions and data configured to cause the processor 410 to perform a certain operation or group of operations.

The communication unit 440 may include any component, device, system, or combination thereof that is configured to transmit or receive information over a network. In some embodiments, the communication unit 440 may communicate with other devices at other locations, the same location, or even other components within the same system. For example, the communication unit 440 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 440 may permit data to be exchanged with a network and/or any other devices or systems described in the present disclosure. For example, the communication unit 440 may allow the system 400 to communicate with other systems, such as computing devices and/or other networks.

One skilled in the art, after reviewing this disclosure, may recognize that modifications, additions, or omissions may be made to the system 400 without departing from the scope of the present disclosure. For example, the system 400 may include more or fewer components than those explicitly illustrated and described.

FIG. 5 is a diagram illustrating an example system 500 which may operate as a block-chain based system to facilitate agreements, in accordance with one or more embodiments of the present disclosure. In some embodiments, the system 500 may include a register 501. In some embodiments, the register 501 may correspond to the register 122 of FIG. 1. For example, in some embodiments, the register 501 may perform operations described with respect to the register 122 of FIG. 1.

In addition or alternatively to the disclosure included elsewhere herein, the register 501 may be configured create and/or store of proxies 502 and/or templates 504. In some embodiments, the register 501 may facilitate the posting of either or both of the proxies 502 and/or the templates 504 to a blockchain (such as the blockchain 110 of FIG. 1.).

The templates 504 may include a framework, sample, or partially completed base implementation of an agreement (e.g., the agreement 128 of FIG. 1) that may be used as the basis for specific instances of agreements based off of the templates 504. For example, the templates 504 may be base implementations. An implementation may be a specification for how an agreement should control the state of the agreement. For example, the templates 504 may store terms for a generic licensing agreement that may serve as the basis upon which specific instances of the licensing agreement are implemented. In some embodiments, the collection of terms may be similar to the express terms 126 of FIG. 1.

The one or more proxies 502 may include a representation of a specific instance of a given agreement that may be based on an identified template 504. that may direct users to the one or more templates 504. In some embodiments, the proxies 502 may be minimal proxies (e.g., clones), which may be immutable. In these and other embodiments, the templates 504 may function as template contracts (e.g., form contracts), which may represent incomplete agreements, and the proxies 502 may provide the terms, values, and/or other data to form and complete the agreements. In these and other embodiments, the template 504 may store the logic, code, and functionality associated with the agreement, and the proxy may only store the data input by a promisor and/or an offeror to complete the agreement. For example, the template 504 may be an incomplete form contract with “fill-in-the blank” dynamic inputs. The proxy 502 may store only the data values to fill in the blanks of the dynamic inputs and complete the agreement, and the proxy 502 may point to the template 504 to execute the logic of the agreement. In some embodiments, the proxy 502 may effectively clone the template 504, but may point to and rely on the template to execute the agreement without having to repost the entire text of the agreement to the blockchain.

In some embodiments, the dynamic inputs may be customizable inputs in the templates 504. In some embodiments, the dynamic inputs may be similar to the express terms. Additionally or alternatively, a combination of the dynamic inputs and the template 504 may be similar to the express terms. In some embodiments, the dynamic inputs may be customizable by either the promisor, the offeror, or both when the template 504 is created. In these and other embodiments, the dynamic inputs may be “fill-in-the-blank” values. For example, the template 504 may be a generic licensing agreement and the template 504 may have a royalty clause where the royalty % is left blank (e.g., The Royalty Rate shall be % of the Net Sales). In the preceding example, either or both of the promisor and the offeror may fill-in the blank of the dynamic royalty rate percentage, which may then be sent to the other party.

In some embodiments, the dynamic inputs may include actually values and may be associated with a given proxy 502. For example, the proxy 502 may point to or otherwise reference a template 504 posted to the blockchain. The dynamic inputs may include one or more values to be placed within the template 504 to fill in the gaps such that the combination of the template 504 and the dynamic inputs create a cohesive and complete agreement. In these and other embodiments, the dynamic inputs may include a pointer to an identified string, variable, or other placeholder within the template as the location to which the given dynamic input is to be inserted.

In some embodiments, the templates 504 may have one or more parameters that may be injected into the templates 504. For example, one or more agreement parameters 506 may be injected into the templates 504. In these and other embodiments, an agreement 508 may be formed based on a minimal clone proxy of the template 504 with the one or more agreement parameters 506 inserted into the template 504. In some embodiments, the agreement parameters 506 may include one or more of an offeror, a promisor, an implementation, a controller, a salt (e.g., used to prevent signature replay for the same agreement), a metadata, and/or an encrypted signatures. For example, the one or more agreement parameters 506 may be inserted into the template 504 to define the agreement 508.

In some embodiments, the controller may be configured to allow external entities to make changes and add extra functionality to agreements. In some embodiments, the controller may be included in the hash of the template 504 when the template 504 is posted to the blockchain. In these and other embodiments, only the controller may post the agreement on the blockchain. In these and other embodiments, the agreement 508 may pass through the controller before the agreement 508 is published in the register 501. In some embodiments, the controller may allow a party to the agreement 508 to change the logic, code, and/or functionality of the template 504 before and/or after the agreement 508 is executed. In these and other embodiments, the controller may be a smart contract and the terms included in the controller may need to be satisfied before the agreement is posted to the blockchain. For example, the agreement may relate to an NFT sale in the intellectual property marketplace and the controller may require a new NFT to be minted before the agreement is posted to the blockchain. Hence, the controller may prevent posting the agreement to the blockchain until a new NFT is minted. When a new NFT is minted, the controller may post the agreement to the blockchain.

In some embodiments, the agreement 508 may be further defined based on one or more actionable modules. In these and other embodiments, the one or more actionable modules may refer to components of the agreement 508 that outline specific actions to be taken by the parties involved (e.g., the promisor and/or the offeror). For example, the actionable modules may include detailed description of responsibilities, timelines, deliverables, and/or other measurable activities that may be required to be performed to fulfill the terms of the agreement 508. The actionable modules may be configured to be filled with variable terms and to execute the appropriate action on the backend in response to the agreement being finalized (e.g., signed by all parties involved). In some embodiments, the system 500 may include a composable ability to generate and/or create any types of actionable modules. For example, the actionable modules may include actionable IP agreement use (e.g., two or more parties engage in use of IP in return for payment (variable terms on payment, time, frequency, inclusion/exclusion of an escrow, etc.)), IP Financing/Lending (e.g., use of an IP agreement with the above exchange value acting as collateral towards a loan), real world assets (RWAs) (e.g., tokenized asset agreements), NFT agreements (e.g., a protocol module that wishes to mint an NFT only after an agreement has been complete between two parties), agreements requiring down payments (e.g., an agreement that requires a down payment to be made before the agreement is considered valid), and/or any other types of modules (e.g., licensing agreements).

In some embodiments, the one or more actionable modules may be attached to the template 504 such that the actionable modules may be included in the agreement 508. For example, the actionable modules may be attached directly to the template 504 to be included in the agreement 508. Additionally or alternatively, the one or more actionable modules may be attached to the controller of the agreement parameters 506. For example, the controller may allow the actionable modules to be injected into the templates 504 such that the actionable modules may be included as part of the agreement 508.

In some embodiments, multiple proxies 502 may point to or otherwise reference a single template 504. In these and other embodiments, the template 504 may be a generic licensing agreement, which may contain the logic and functionality of the agreement. For example, the offeror may execute a license with the first promisor, a second license with the second promisor, and a third license with the third promisor. One proxy 502 may be created for each license, but each proxy 502 may point to and rely on the same generic licensing template 504. Continuing the example, instead of three full instances of the agreement 128 being posted to the blockchain, the template 504 and the three proxies 502 may be posted to the blockchain, which may reduce the overall computational effort (e.g., gas) utilized to execute and perform any functions related to the agreement or posting to the blockchain. Additionally or alternatively, utilizing the combination of proxies 502 and templates 504 may also reduce the amount of storage taken up by the blockchain because the template 504 may contain the logic, code, and functionality of the agreement in one block, and the proxies 502 which point to the template 504 may only need to store the data necessary to make the agreement complete.

In some embodiments, a staged process may be utilized in posting the template 504 and/or the proxy 502 to the blockchain. For example, rather than posting the strings of the template 504 to the blockchain, it may be more efficient to convert the strings of text of the template 504 into bit values representative of the text strings, and then post the bit values to the blockchain. Doing so may conserve or reduce the amount of computing resources as compared to posting the template 504 to the blockchain as verbatim text strings.

In some embodiments, an addendum chain may serve as a record of all changes made to an associated template 504 and/or proxy 502. For example, for a given proxy 502, the addendum chain may serve as a record of the back and forth between the parties to the agreement as variations from the template 504. As another example, for a given template 504, the addendum chain may include a generic licensing agreement that includes a specific percentage of royalty as a starting point, the parties may negotiate back and forth to an agreed upon royalty, and the addendum chain may provide a record of the negotiations between the parties. In some embodiments, the addendum chain may serve as a chronological record. In these and other embodiments, each addendum in the addendum chain may be a block in the blockchain (or on another blockchain) such that the back-and-forth negotiations represent an immutable record of the negotiations. In these and other embodiments, the blocks associated with the addendum chain may be encrypted in a manner that prevents others from observing the contents of the addendum chain aside from the parties to the agreement. In some embodiments, the addendum chain and/or a pointer to the blocks associated therewith may be included as part of the proxy 502.

In addition or alternatively to the disclosure included elsewhere herein, the escrow 150 may be configured to receive and hold assets (including, for example, cryptocurrency, digital currency, or any other electronic asset) during a transaction. The escrow 550 may help prevent relevant assets from being transferred if the template 504 requires locking of the asset. For example, in an NFT marketplace the NFT may be transferred to the escrow 550 and the template 504 may require that the NFT be held in the escrow 550 until payment is received by the seller.

Modifications, additions, or omissions may be made to the system 500 without departing from the scope of the disclosure. For example, the designations of different elements in the manner described is meant to help explain concepts described herein and is not limiting. As another example, the system 500 may include any number of other elements or may be implemented within other systems or contexts than those described.

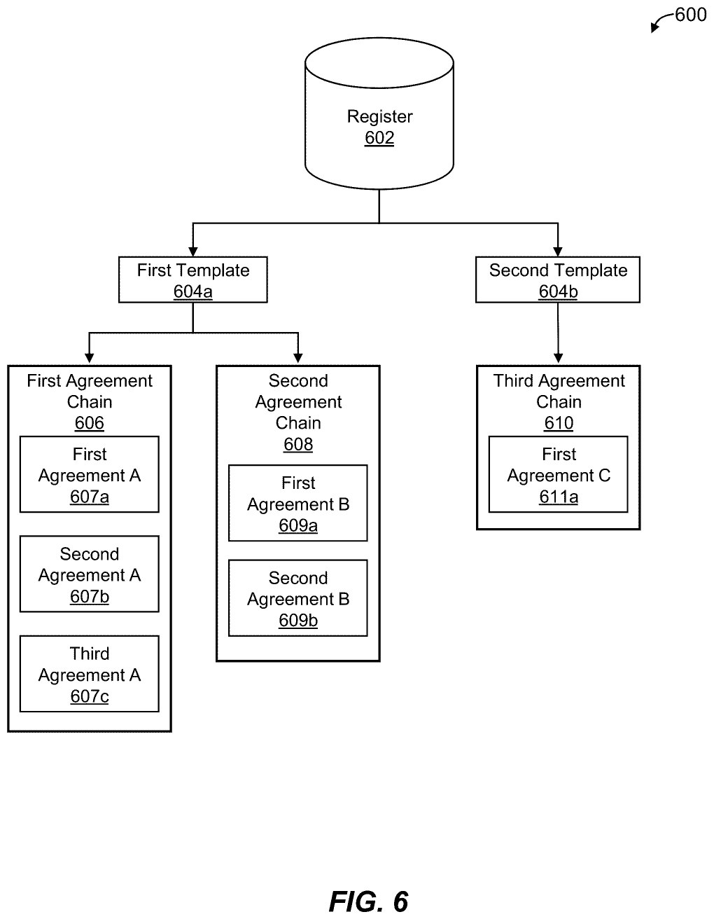

FIG. 6 illustrates an example system 600 configured to facilitate agreements between parties, in accordance with one or more embodiments of the present disclosure. In some embodiments, the system 600 may correspond to the system 100 of FIG. 1, and/or the system 500 of FIG. 5. In some embodiments, the system 600 may be configured to provide a platform in which parties may use to create an agreement.

In some embodiments, the system 600 may include a register 602. The register 602 may be a centralized control point for contract management. For example, the register 602 may be a singleton contract configured to deploy and/or implement agreements between the parties. In some embodiments, the register 602 and/or the system 600 may be configured to communicate with a blockchain such that the agreements may be posted. In some embodiments, the communication between the system 600 and the blockchain may be performed in a similar manner as the communication between the central system 120 and the blockchain 110 of FIG. 1

In some embodiments, the register 602 may include one or more templates. For example, the register 602 may include a first template 604a and a second template 604b (collectively referred to as “the templates 604”). While illustrated with two templates 604, the register 602 may include any suitable number of templates. In some embodiments, the templates 604 may include frameworks, samples, and/or partially completed base implementations of agreements. In some embodiments, the templates 604 may be base implementations of different types of agreements. For example, the first template 604a may include a template for an employee agreement, and the second template 604b may include a template for a non-disclosure agreement (NDA). In some embodiments, the templates 604 may correspond to the templates 504 of FIG. 5. In some embodiments, the parties may use the templates 604 in forming the contracts.

In some embodiments, the templates 604 may set out general terms of corresponding type of agreement. For example, the first template 604a may set out general terms of an employee agreement with variables and/or terms that may be customized such as employment terms, salaries, benefits, among others. In these and other embodiments, agreements may be generated based on the templates 604. For example, the agreements may be clones of the templates 604 with specific information associated with the parties integrated. In some embodiments, the templates 604 may be filled using express terms, such as the express terms or fillable information. The express terms may be described in further detail in the present disclosure, such as with respect to the express terms 126 of FIG. 1.

In some embodiments, the register 602 may be or be controlled by a notary, or a centralized signer. The notary may be responsible for verifying the agreements. For example, the notary may verify the identities of the parties and terms of the agreements, among others. Additionally or alternatively, the notary may verify that all responsible parties have provided required signatures on the agreements.

In some embodiments, multiple agreements may be generated using the same template. For example, an employer may generate an employment contract with a first employee and a second employee. For example, the employer may use the first template 604a (e.g., an employment contract) to generate agreements with the first employee and the second employee. For example, a first agreement chain 606 may include one or more agreements that may be generated between the employer and the first employee, and a second agreement chain 608 may include one or more agreements that may be generated between the employer and the second employee.

In some embodiments, the agreement chains (e.g., the first agreement chain 606 and/or the second agreement chain 608) may include different versions of agreements. For example, the first agreement chain 606 may include one or more versions of the employment agreement between the employer and the first employee. For example, the first agreement chain 606 may include a first agreement A 607a, a second agreement A 607b, and a third agreement A 607c. While illustrated as having three agreements, the first agreement chain 606 may include more or less agreements.

In some embodiments, different versions of agreements within the same agreement chain may stem from a same template (e.g., the first template 604a) between substantially the same parties. For example, the first agreement A 607a, the second agreement A 607b, and the third agreement A 607c included in the first agreement chain 606 may stem from the first template 604 between the employer and the first employee. For example, the first agreement A 607a may be a first and/or initial employment agreement between the employer and the first employee. The second agreement A 607b may be a second and/or updated employment agreement between the employer and the first employee. In some embodiments, the second agreement A may differ from the first agreement A with respect to one or more features and/or variables. For example, the second agreement A 607b may include a different salary from the first agreement A 607a, and the third agreement A 607c may differ from the second agreement A 607b. In some embodiments, the differences between different versions of the agreements (e.g., the first agreement A 607a and the second agreement A 607b) may be minor. For example, the second agreement A 607b may be a renewal of the first agreement A 607a in which instance, the only difference may be the dates and/or periods of the agreements.

In some embodiments, the differences between the different versions may be more substantial. For example, the terms and/or features may be added and/or removed between the different versions. For example, continuing the example of employment contracts, the second contract A 607b may include additional terms, such as additional benefits (e.g., stock options) compared to the first contract A 607a. In some embodiments, the register 602 may allow the parties to modify and/or update the agreements compared to the templates 604 with a higher level of freedom. For example, the parties may modify the templates 604 without substantial restrictions. For example, the templates 604 may provide guideline and/or basic structures for the agreements that the parties may customize. In these and other embodiments, the register 602 may validate the information used to customize the agreements such that the agreements are still valid after the customization by the parties.

In some embodiments, the register 602 may allow the parties to insert different types of data into the agreements. For example, the register 602 may allow the parties to enter text data into the agreements. Additionally or alternatively, the register 602 may allow the parties to enter data as HTML.

In some embodiments, the same template may be used multiple times by the same parties and/or different parties. For example, the second agreement chain 608 may include agreements between the employer and the second employee. For example, the second agreement chain 608 may include a first agreement B 609a and a second agreement B 609b. In these and other embodiments, while the first agreement chain 606 and the second agreement chain 608 are both generated based on the first template 604a, agreement chains may include different agreements. For example, in some embodiments, the first agreement A 607a and the first agreement B 609a may include one or more different variables. For example, the first employee associated with the first agreement chain 606 and the second employee associated with the second agreement chain 608 may have different job requirements, compensation, location, among others.

In some embodiments, individual agreements may include a pointer to next agreement in the chain. For example, the first agreement A 607a may include a pointer to the second agreement A 607b such that the first agreement A may be updated without losing history of the first agreement A. In some embodiments, a number of valid agreements within a agreement chain, at a given instance, may be limited. For example, only one agreement may be held valid from one or more agreements within the same agreement chain. In these and other embodiments, in response to an updated version of an agreement being generated (e.g., the second agreement A 607b being generated after the first agreement A 607a), the prior version of the agreement may be invalidated and/or voided with a pointer to the newer version. In these and other embodiments, the invalidated and/or voided versions may be accessible (e.g., stored) but may not be enforceable and/or valid.

In instances, in which only a first or initial version of an agreement exists, an agreement chain may only include the initial version and the initial version may not include any pointers. For example, a first agreement C 611a may be generated based on the second template 604b. For example, the first agreement C 611a may be an NDA between two parties. A third agreement chain 610 corresponding to the first agreement C 611a may be formed, and the first agreement C 611a may be added to the third agreement chain 610. In such instances, the first agreement C 611a may not include a pointer as the first agreement C 611a is the only agreement in the third agreement chain 610. In instances in which a second agreement C is generated including updates from the first agreement C 611a, the second agreement C may be added to the third agreement chain 610, the first agreement C 611a may be invalidated, and the first agreement C 611a may be assigned a pointer to the second agreement C.

In some embodiments, the register 602 may be configured to facilitate payment between the parties. For example, the register 602 may include an escrow (e.g., the escrow 150 of FIG. 1). The escrow may include a wallet, an account, a financial system, or any other component configured to receive and hold assets during a transaction.

Modifications, additions, or omissions may be made to the system 600 without departing from the scope of the disclosure. For example, the designations of different elements in the manner described is meant to help explain concepts described herein and is not limiting. As another example, the system 600 may include any number of other elements or may be implemented within other systems or contexts than those described.

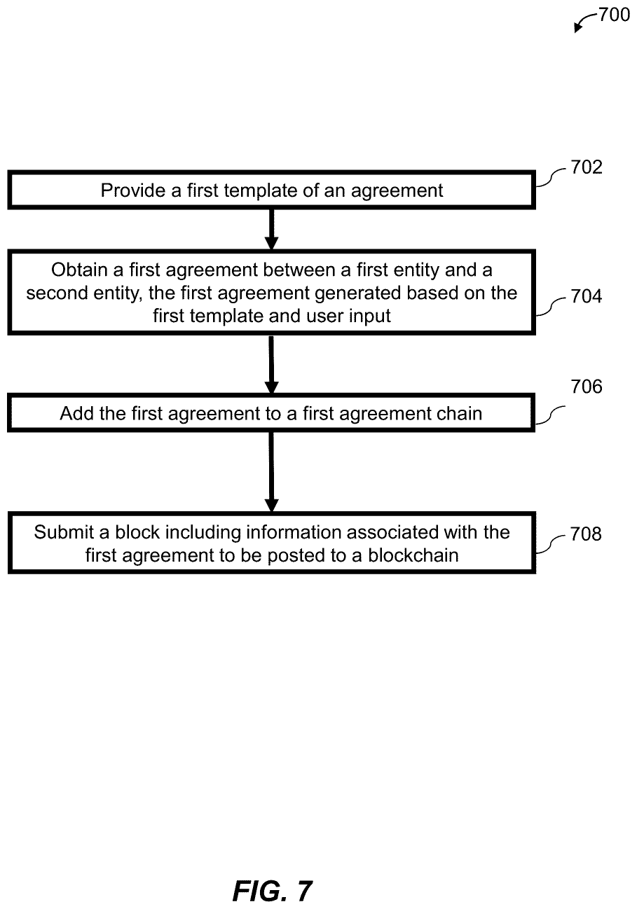

FIG. 7 is a flow chart of an example method 700 of generating an agreement, arranged in accordance with at least one embodiment of the present disclosure. One or more operations of the method 700 may be implemented by any suitable element or a computing system such as the computing system 400 of FIG. 4. Although illustrated as discrete steps, various steps of the method 300 may be divided into additional steps, combined into fewer steps, or eliminated, depending on the desired implementation. Additionally, the order of performance of the different steps may vary depending on the desired implementation.

In some embodiments, the method 700 may begin at block 702. At block 702, a first template of an agreement may be provided. For example, a register may provide the first template. In some embodiments, the first template may represent a clone agreement for any suitable types of agreements. For example, the first template may be associated with a first type of agreement. In some embodiments, the first template may include a basic clone of an agreement. For example, the first template may provide a skeleton agreement that may be modified and/or filled out by one or more parties. For example, the first agreement may include one or more terms associated with the first type of agreement. In some embodiments, the terms may be represented as variables and/or blank spaces that may be filled out by different entities. In some embodiments, the first template may be modified and/or revised by the parties and/or users. In some embodiments, the terms may include any suitable types of data. For example, the terms may include textual data, html data, image data, among others. In some embodiments, the first template may correspond to the template 504 of FIG. 5 and/or the first template 604a of FIG. 6.

At block 704, a first agreement between a first entity and a second entity may be obtained. In some embodiments, the first agreement may be generated based on the first template and user input. For example, the user input may be used to fill in the variables and/or the blank spaces of the first template to form the first agreement. In some embodiments, the user input may be provided by the first entity and/or the second entity. In some embodiments, the first agreement may be modified based on the user input. For example, the user input from the parties (e.g., the first entity and/or the second entity) may specify certain requirements and/or specific terms of the first agreement. In these and other embodiments, the first template may serve as a base for generating the first agreement. In some embodiments, the modifications to the first template may be represented in terms of one or more actionable modules such as described with respect to FIG. 5 of the present disclosure. In some embodiments, the first agreement may include one or more attachments as part of the first agreement. For example, the attachments may include other contracts, agreements, PDFs images, appendices, and/or any other information that may provide additional information about the first agreement.

At block 706, the first agreement may be added to a first agreement chain. In some embodiments, the first agreement chain may include a chain of agreements that may be generated from the first template. For example, the first agreement chain may include different versions of the first agreement as the first agreement is updated.

For example, in some embodiments, the method 700 may further include obtaining a second agreement generated based on the first agreement and additional user input. In these and other embodiments, the second agreement may be at least partially different from the first agreement. For example, the second agreement may be an updated and/or modified version of the first agreement. in these and other embodiments, the second agreement may be added to the first agreement chain following the first agreement. In response to the second agreement being added to the first agreement chain, the first agreement may be invalidated and a first pointer may be assigned to the first agreement. The first pointer may be pointing to the second agreement such that when the first agreement is accessed by a user, the user may be made aware of existence of the second agreement. In some embodiments, a block including information associated with the second agreement may be posted to a blockchain. In some embodiments, the method 700 may further include identifying differences between the first agreement and the second agreement. For example, the differences may be highlighted and/or noted such that the user may be made aware of the differences.

At block 708, a block including information associated with the first agreement may be posted to the blockchain. In some embodiments, operations of positing to the blockchain may be described with further detail in the present disclosure, such as with respect to the blockchain 110 of FIG. 1.

Modifications, additions, or omissions may be made to the method 700 without departing from the scope of the present disclosure. For example, one skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, in some embodiments, the method 700 may include, prior to adding the first agreement to the first agreement chain, validating the first agreement based on one or more validation parameters. For example, the terms of first agreement may be validated and/or filtered. In some embodiments, the validation process may include notarizing the first agreement.

In some embodiments, the method 700 may further include obtaining a third agreement generated based on the first template and new user input. In some embodiments, the third agreement may be unrelated to the first agreement. For example, instead of being an modified and/or updated version of the first agreement, the third agreement may be independent of the first agreement. For example, the third agreement may be made between different parties and/or the subject of the agreement may be different from the first agreement. In these and other embodiments, the third agreement may be added to a second agreement chain. The second agreement chain may be distinct form the first agreement chain. For example, a user accessing the first agreement chain may not view the agreements (e.g., the third agreement) included in the second agreement chain. In some embodiments, a block including information associated with the third agreement may be posted to the blockchain.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method comprising:
providing a first template of an agreement;
obtaining a first agreement between a first entity and a second entity, the first agreement generated based on the first template and user input;
adding the first agreement to a first agreement chain; and
submitting a block including information associated with the first agreement to be posted to a blockchain.

2. The method of claim 1, further comprising:
obtaining a second agreement generated based on the first agreement and additional user input, the second agreement being, at least partially, different from the first agreement;
adding the second agreement to the first agreement chain following the first agreement;
invalidating the first agreement;
assigning a first pointer to the first agreement, the first pointer pointing to the second agreement; and
submitting a block including information associated with the second agreement to be posted to the blockchain.

3. The method of claim 2, further comprising:
identifying differences between the first agreement and the second agreement.

4. The method of claim 1, further comprising:
prior to adding the first agreement to the first agreement chain:
validating the first agreement based on one or more validation parameters.

5. The method of claim 4, wherein validating the first agreement includes notarizing the first agreement.

6. The method of claim 1, wherein the first agreement includes an attachment as part of the first agreement.

7. The method of claim 1, wherein the first template is associated with a first type of agreement, the first template including one or more terms associated with the first type of agreement.

8. The method of claim 1, further comprising:
obtaining a third agreement generated based on the first template and new user input, the third agreement being unrelated to the first agreement;
adding the third agreement to a second agreement chain, the second agreement chain being distinct from the first agreement chain; and
submitting a block including information associated with the third agreement to be posted to the blockchain.

9. The method of claim 1, wherein the first template includes one or more variable terms corresponding to at least a part of the user input.

10. The method of claim 1, wherein the user input is used to generate one or more actionable modules.

11. A system comprising:
one or more processors; and
one or more non-transitory computer-readable media containing instructions which, when executed by the one or more processors, cause the system to perform one or more operations, the operations comprising:
providing a first template of an agreement;
obtaining a first agreement generated based on the template and user input;
adding the first agreement to a first agreement chain; and
submitting a block including information associated with the first agreement to be posted to a blockchain.

12. The system of claim 11, the operations further comprising:
obtaining a second agreement generated based on the first agreement and additional user input, the second agreement being, at least partially, different from the first agreement;
adding the second agreement to the first agreement chain following the first agreement;
invalidating the first agreement; and
assigning a first pointer to the first agreement, the first pointer pointing to the second agreement.

13. The system of claim 12, the operations further comprising:
identifying differences between the first agreement and the second agreement.

14. The system of claim 11, the operations further comprising:
prior to adding the first agreement to the first agreement chain:
validating the first agreement based on one or more validation parameters.

15. The system of claim 14, wherein validating the first agreement includes notarizing the first agreement.

16. The system of claim 11, wherein the first agreement includes an attachment as part of the first agreement.

17. The system of claim 11, wherein the first is associated with a first type of agreement, the first template including one or more terms associated with the first type of agreement.

18. One or more non-transitory computer-readable media storing instructions that, when executed by one or more processors, cause a system to perform operations, the operations comprising:
receiving identified express terms via which an offeror is willing to convey ownership in a non-fungible token (NFT) to another party;
receiving from a promisor a willingness to enter into an agreement according to the express terms to obtain ownership in the NFT;
generating the agreement including the express terms;
obtaining signatures from each of the promisor and the offeror for the agreement; and
submitting a block including information associated with the agreement to be posted to a blockchain.

19. The one or more non-transitory computer-readable media of claim 18, the operations further comprising:
receiving into an escrow a digital asset from the promisor according to the agreement;
conveying the NFT to the promisor; and
conveying the digital asset from the escrow to the offeror.

20. The one or more non-transitory computer-readable media of claim 18, wherein the information associated with the agreement includes one of a hash value of the agreement or an encrypted form of the agreement.
